(19) United States
(12) Patent Application Publication
(10) Pub. No.: US 2014/0267551 A1
(43) Pub. Date: Sep. 18, 2014

(54) Device with Background Composition Module

(71) Applicants: Yi-Chuan Cheng, Changhua County (TW); Kuo-Ching Chiang, New Taipei City (TW)

(72) Inventors: Yi-Chuan Cheng, Changhua County (TW); Kuo-Ching Chiang, New Taipei City (TW)

(21) Appl. No.: 14/217,383

(22) Filed: Mar. 17, 2014

(30) Foreign Application Priority Data
Mar. 18, 2013 (TW) 102109560

(51) Int. Cl. H04N 7/15

(52) U.S. Cl. CPC H04N 7/15
USPC 348/14.03

(57) ABSTRACT

A portable communication, comprises a control unit, a display coupled to the control unit; a memory is coupled to the control unit. A background database is stored in the memory, wherein a background is selected from the background database; a background composition module is coupled with the control unit for composting user input signal and the selected background to generated a composted signal; and followed by transmitting the composited signal.

### TECHNICAL FIELD

The present invention relates to a portable communication device, particularly to a portable device having background composition module.

### BACKGROUND OF RELATED ART

Because of the development of the information technology (IT), the information could be exchanged with higher capacity and faster speed. Internet is designed as an open structure to exchange information freely without restriction. The third generation mobile phone standard allows the user to access video communication through the air. Thus, certain communication service requiring real time information exchange, such as viewing a live video, has become feasible through mobile phone communication network or Internet. Portable computers and personal computer or smart phone have been widely used for each area. Laptop (notebook) and tablet style computers may be found in the work environment, at home or used during travel, perhaps as a result of their advantages, particularly when equipped with wireless communicating technology. Advantages such as low power consumption, small size, low weight make the portable computer available to nearly everyone everywhere. Smart TV is a new product for nowadays as well.

### SUMMARY

The portable device with dual network linking capability module is used to transmit information through a RF module via the cellular network or the wireless local area network (WLAN) module via the Internet, wherein the portable device includes an internet communication module and the WLAN module to allow an user may synchronously transmit or receive data through the internet, portably, wherein the transmitted information is selected from audio signal, video signal and the combination thereof. The terminal can be a computer, a personal digital assistant (PDA), a notebook, cellular, tablet or a smart phone, which is able to access the internet network via the local area network. The system further comprises a mobile phone communication service network.

A portable communication device with a background composition module includes: a control unit; a display is coupled to the control unit and a memory is coupled to the control unit. A background module is stored in the memory, and a background database in the memory, wherein the background module is triggered and a background is selected from the background database; a background composition module is coupled with the control unit for composting user input signal and the selected background to generated a composted signal; and followed by transmitting the composited signal.

A filter is coupled with the control unit to filter out a real background. The background is selected from voice, image or the combination. The user input signal is selected from voice, image or the combination. The background includes a train station, an airport, a street, a department store, a hospital, a market, a shopping mall, a supermarket, an office, a meeting room, a factory, a classroom, an exhibition. A phone filtering out module is coupled with the control unit to filtering out a phone number selected by a user. A character simulation module and a character database is coupled to the character simulation module, wherein the character simulation module is coupled with the control unit. The character simulation module is provided to select a character in the character database. The character simulation module is provided to module a user voice into a selected character.

### BRIEF DESCRIPTION OF THE DRAWINGS

For a better understanding of the present invention and to show how it may be implemented, reference will now be made to the following drawings:

FIG. 1 is a block diagram showing the device of the present invention.

FIG. 2 is a block diagram showing the device of the present invention.

FIG. 3 is a block diagram showing the device of the present invention.

FIG. 4A-4B show the ranking module of the present invention.

FIG. 5 is a block diagram showing the device having background composition module of the present invention.

FIG. 6 is a block diagram showing the device having voice simulation module of the present invention.

FIG. 7 is a flow chart of the present invention.

FIG. 8 is a flow chart of the present invention.

### DETAILED DESCRIPTION

The present invention is described with the preferred embodiments and accompanying drawings. It should be appreciated that all the embodiments are merely used for illustration. Hence, the present invention can also be applied to various embodiments other than the preferred embodiments.

Referring to FIG. 1, it illustrates the functional diagram of the portable device 10 with dual networks capability. The dual way portable terminal 10 with SIM card connector to carry the SIM card, it is well known in the art, the SIM card is not necessary for some other type of cellular such as PHS or some CDMA system. The diagram is used for illustrating and not used for limiting the scope of the present invention. Please refer to FIG. 1. The portable terminal or device 10 includes a first and a second wireless data transferring modules 200A, 200B. The first wireless data transferring module 200A could be video RF module to transmit or receive mobile phone signal and it is well known in the art. As know in the art, the RF unit is coupled to an antenna system 105. The RF module may include base band processor and so on. This antenna is connected to a transceiver, which is used to receive and transmit signal. The first wireless data transferring modules 200A is compatible to the mobile phone protocol such as W-CDMA, CDMA2000, CDMA2001, TD-CDMA, TD-SCDMA, UWC-136, DECT, 4G system. There systems allow the user communicates with video communication. The RF module may perform the function of signal transmitting and receiving, frequency synthesizing, base-band processing and digital signal processing. The SIM card hardware interface is used for receiving a SIM card. Finally, the signal is send to the final actuators, i.e. a vocal I/O unit 153 including loudspeaker and a microphone. The module 200A, 200B can be formed by separated module (chip) or integrated chip.

The device 10 may include DSP 120, CODEC (not shown) and A/D converter 125 as well. The present invention includes a central control unit 100, a wired input/output) 150, a build-in display 160, OS (operation system) 145 and memory 155 including a ROM program memory, a RAM memory and a nonvolatile FLASH memory. All of the units mentioned above are coupled to the central control unit 100, respectively. The memory could be micro-type hard disc. The wired I/O interface 150 is coupled to the central control unit 100. The wired I/O interface could be USB, IEEE1394. An audio/video I/O 190 is coupled to between the A/D converter 125 and the Mic. and speaker 153.

The device 10 further includes the second wireless data transferring modules 200B. In one embodiment, a wireless local area network (WLAN) module is employed and it could be compatible to the local area network protocol or standard such as Bluetooth standard, Wi-Fi standard, or 802.11x (x refers to a, b, g, n) standard compatible module. Further, the wireless local area network (WLAN) module could be compatible to the WiMAX (Worldwide Interoperability for Microwave Access) standard or specification. An Internet phone module 130 are coupled to the central control unit 100 to allow transmit and receive the audio, video or both type signal to/from the internet network through the wireless local area wireless transmission module. Internet phone module 130 at least meets the standard of terminal-terminal Voice Over Internet Protocol (VoIP). One of the examples is Skype compatible protocol. By using of the Internet phone module 130 and the wireless local area network module 200B, the user may portably, synchronously transmit and receive the vocal, video or both signal through the internet by using the internet (software) phone module 130. The present invention defines a hand-held device having VoIP phone module and wireless WiFi or WiMax network linking module coupled to the VoIP phone module to allow the user to make a wireless terminal-terminal VoIP phone without power on the PC. The voice over internet protocol (VoIP) phone module is used to encode or convert the voice signal into VoIP protocol within the portable communication device before transmitting the signal, followed by programming the signal into WiFi or WiMax format in order to transmit the voice signal through the wireless network, especially, the Skype phone.

As we can see, computing devices are coupled to Internet network, and the computing devices could be but not limited to the Smart TV, tablet PC, notebook, cellular or the smart phone, which are able to access the Internet. The data exchange between the terminals could be implemented directly through the Internet. Apparently, the computing devices includes the terminal-to-terminal VoIP system, such as Skype Phone system or the on-line instant chat system, application or module and from the FIG. 1, the terminals maybe coupled directly by network without the client-server system for the VoIP. Unlike server-client system, the present invention is a terminal-to-terminal system or semi-terminal-to-terminal system rather than a client-server system, and makes use of background processing on computing devices running software. Thus, it may allow the computing device to communicate with other terminals without server-client structure. An image capturing module 152 is required and coupled to the central control unit 100 to catch the video image if the user would like to conduct the real-time video transmission. The image capturing module 152 could be digital still camera, digital video camera. Therefore, the real-time portable conference is possible. In another embodiment, the one difference is that the device may omit the RF module. If the device 10 includes 3G or higher level RF module, the user may transmit the video phone through the air. Therefore, the user may select one of the schemes to make a video call through internet or air depending on the user demand. If the device is within the hot spot area, the user may choose the usage of the internet phone module for communication due to cheaper transmitting fee. If the out of the hot spot range, the other option for video communication is provided. Typically, the WCDMA signal is less restricted by the geography limitation, but the transmission fee is higher. The present invention allows the user to select the proper wireless module for video communication. If the user would like to conduct the video communication through WiFi or WiMax, the method includes coupling to internet or hot spot, followed by activating the internet (software) phone module. Subsequently, vocal signal is input from the speaker and image data is captured from the image capture device, subsequently, the image data and the vocal signal are converted from signal to digital. After the conversion, the image data and the vocal signal are composition, compressed or processed to form a data streams. Therefore, the data may be transmitted to the receiving party seriously. BER of less than about 10.sup.−5 at the channel decoder output is considered desirable for digital music and video transmissions. The bits in a given source coded bit stream (e.g., a compressed audio, image or video bit stream) often have different levels of importance in terms of their impact on reconstructed signal quality. As a result, it is generally desirable to provide different levels of channel error protection for different portions of the source coded bit stream. Techniques for use in providing such unequal error protection (UEP) through the use of different channel codes are described in U.S. patent application Ser. No. 09/022,114, filed Feb. 11, 1998, and entitled “Unequal Error Protection for Perceptual Audio Coders,”. A source coded bit stream is divided into different classes of bits, with different levels of error protection being provided for the different classes of bits.

The device may couple to the internet via the wired data I/O interface or the WLAN module 200 B to upload or download data including digital data such as text format, image format, audio signal, video signal. The wired data I/O interface 150 is coupled to the central control unit 100. The application of the apparatus is quite economical and convenience. Moreover, the user may call other one by the internet phone module to reduce the transmission fee when the local area wireless transmission module detects the signal of the internet network. Otherwise, the user may use the WCDMA for video communication. The portable real-time video conference is possible by implementation of the present invention. Further, the present invention provides dual modes (3G or internet video phone) portable audio/video communication, synchronously.

FIG. 2 illustrate alternative embodiment of the present invention, almost of the elements are similar to FIG. 1, the detailed description is omitted. A signal analysis 102 is provided to analysis the signal strength of the dual communication module 200A, 200B. The result will be fed into the module switch 102 to automatically to switch the module or set by manual through the standby setting interface 185. In order to implant the multi-parties video communication, the device 10 includes an image division unit 106 coupled to the control unit 10 to division the displaying area on the display to display the received images synchronicity. Therefore, multi-parties video communication is achieved. The received images will be assigned to the divided displaying area on the display and the displaying areas may be separated, overlap or partial overlap.

Please turning to FIG. 3, the present invention also includes a multi-tasking module coupled to the control unit as shown in FIG. 3. In computing filed, the multitasking 500 refer to a method where multiple tasks (also known as processes) share common processing resources such as a CPU. In the case of a computer with a single CPU, only one task is to be running at any point in time. Multitasking solves the problem by scheduling which task may be the one running at any given time, and when another waiting task gets a turn. The multi-tasking allow reassign the control unit from one task to another to achieve parallelism or context switches. Thus, the multi-tasking module may reassign the control unit to switch from one process to another different process to facility context switches. For example, a plurality of fed images is transmitted to the multi-tasking module 500 for processing the received images from multi-parties. The images will be processed by the image division unit 106 before sending the image data signals to the display 160. Image processing unit 510 maybe employed to adjust the processed image before displaying. Thus, the multi-tasking module may allow the control unit to process the video image from one party to another party; or adjust the processed image of one party and displaying image of the same party. The present invention relates generally to a computing or portable device. The device includes but not limited to smart TV, cellular phone, PDA (personal digital assistant), smart phone, notebook, digital still camera, digital video camera, medium player (MP3, MP4), GPS and the equivalent thereof.

FIG. 5 shows another alternative embodiment, the identical reference number refers to the same device or elements mentioned in above embodiments. The present embodiment further includes the ranking module 1700 which is coupled to the control unit to analysis the most favorite contact person, website, or skype user. The module may be incorporated into the cellular device and smart phone or tablet computer as shown in the FIG. 1. In the case, the ranking module 1700 is coupled with the control unit 100 in FIG. 5. The ranking is based on the number of time (or frequency) of communication between the user and the contact person within a period of time or the number of time (or frequency) that the user links to the website within a period of time. Therefore, the ranking module 1700 will have the communication or website linking frequency data calculated by the ranking module 1700 or additional counter of the devices. It will rank my favorite dynamically and display the high ranking contact person, website, or skype user on the interface of desk top or the interface of the address book (or phone number book), account book, my favorite interface dynamically as show in FIGS. 4A and 4B. The ranking module 1700 will re-arrange the queue of the contact person and its related information, such as phone number, e-mail address, user account dynamically based on the frequency of use. If the ranking is altered, the ranking module 1700 will change and re-arrange the queue of the contact person, website, or skype user. The displaying method could be text, image type to show the corresponding account, user or website. In the prior art, the phone number is listed based on the alphabet. For example, if the first alphabet of a user's name is A, he or she will be always listed at the top of the list, however, the people's name starting with A does not contact with user frequently, namely, not high ranking. The module 1700 can be used in the cellular (or computer, tablet) to dynamically re-arrange the list of the address book, contact book or the phone number book based on the frequency of usage to allow the most high ranking person or website will be listed on the top of the list or first page of the user interface.

The device also includes phone filter 1800 coupled to the control unit as shown in FIG. 5. The phone filter 1800 includes an interface on the display to allow the user to input the black list of person and corresponding phone number. When the signal of the incoming phone is received, the phone filter 1800 will check whether or not the phone number is listed on the black list. If the incoming phone is already listed in the black list, the phone filter 1800 will hand off the phone automatically without the user action.

FIG. 6 shows another alternative embodiment of the present invention, the identical reference number refers to the same device or elements mentioned in above embodiments. The present embodiment further includes a background module 1900 and the background database 1950. The user may select the ranking module desired background sound from the background database 1950 via the background module 1900 during or before communication. The background database provides a plurality of background sound 1700 for the user to select, such as train stations, airports, streets, department store, hospitals, markets, shopping mall, supermarket, golf course, offices, meeting rooms, factories, classrooms, exhibition, and background noise. After the user selects, the selected background sound will be composited with the user voice composition to transmit to the counterparty. The background database 1950 may include image or video background. When the module 1900 is activated, a user can transmits the composited image or video calling or answering party after the users chooses the background, the composited video or image is composited by the background video and the user image captured by the image capture device, followed by transmitting to the counterparty through the transmission device. When the people the user does not want to talk to contact to the user, the user can select the background sound or noise, and the user has the excuse to hang up the phone; in another situation, the user does not want the calling or answering party clearly knows where the user is, the user may initiates the background module to let the receiver receives the fake location background sound or noise. The above modules are software or firmware or application. Please refer to FIG. 7, the user can trigger background module 1900 in step 7000, its implementation can be performed through hardware or software of handheld communication devices, such as the control unit, and stored in the memory of the handheld communications device, it is well-known to the people having ordinary skill in the art. The application software or APP will have a user interface to facilitate the operation or input, namely, the background module 1900 also provides a user interface for the user to select the desired background sound or image, video, in other words, the user can select the background from the database after the user input from the interface in step 7100, followed by compositing the user voice and background by the compositing module background module 2000 to generate composted signal. After the output of the composited signal, the composited signal is transmitted. 7300. In another embodiment example, the real background can be selectively filtered out to achieve better results by hardware or software, in step 7150 before composition.

In one embodiment of the present invention, see FIG. 8, voice simulation modulation 2100 is coupled with the control unit, and is trigger in step 8000, the present invention also provides voice simulation database 2150 in the memory of the present invention. The user may select the desired voice from the database 2150 in step 8100. The users can choose in the database 2150 via the user interface, such as Mickey Mouse, Donald Duck, Spider-Man and other characters. After the user selects the desired characteristic's voice, the voice simulation modulation will alter the user voice to the simulated characteristic's voice frequency in step 8200, followed by outputting the simulated voice in step 8300. Under the hardware architecture or multi-core processor support, the benefit can be achieved. Therefore, the user can simulate a special sound to communicate with each other to achieve entertainment effects.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

We claim:

1. A portable communication device with a background composition module, comprising:
a control unit;
a display coupled to said control unit;
a memory coupled to said control unit;
a background database stored in said memory, wherein a background is selected from said background database;
a background composition module coupled with said control unit for composting user input signal and said selected background to generated a composted signal; and followed by transmitting said composited signal.

2. The device as set forth in claim 1, further includes a filter coupled with said control unit to filter out a real background.

3. The device as set forth in claim 1, wherein said background is selected from voice, image or the combination.

4. The device as set forth in claim 1, wherein said user input signal is selected from voice, image or the combination.

5. The device as set forth in claim 1, wherein said background includes a train station, an airport, a street, a department store, a hospital, a market, a shopping mall, a supermarket, an office, a meeting room, a factory, a classroom, an exhibition.

6. The device as set forth in claim 1, further comprising a phone filtering out module coupled with said control unit to filtering out a phone number selected by a user.

7. The device as set forth in claim 1, further comprising a character simulation module and a character database coupled to said character simulation module, wherein said character simulation module is coupled with said control unit.

8. The device as set forth in claim 7, wherein said character simulation module is provided to select a character in said character database.

9. The device as set forth in claim 8, wherein said character simulation module is provided to module a user voice into a selected character.

10. A portable communication device, comprising:
a control unit;
a display coupled to said control unit;
a memory coupled to said control unit;
a background module in said memory, and a background database in said memory, wherein said background module is triggered and a background is selected from said background database;
a background composition module coupled with said control unit for composting user input signal and said selected background to generated a composted signal; and followed by transmitting said composited signal;
a character simulation module and a character database coupled to said character simulation module, wherein said character simulation module is coupled with said control unit.

11. The device as set forth in claim 10, wherein said character simulation module is provided to select a character in said character database.

12. The device as set forth in claim 11, wherein said character simulation module is provided to module a user voice into a selected character.

13. The device as set forth in claim 10, further includes a filter coupled with said control unit to filter out a real background.

14. The device as set forth in claim 10, wherein said background is selected from voice, image or the combination.

15. The device as set forth in claim 10, wherein said user input signal is selected from voice, image or the combination.

16. The device as set forth in claim 10, wherein said background includes a train station, an airport, a street, a department store, a hospital, a market, a shopping mall, a supermarket, an office, a meeting room, a factory, a classroom, an exhibition.

17. The device as set forth in claim 10, further comprising a phone filtering out module coupled with said control unit to filtering out a phone number selected by a user.
